(19) United States
(12) Patent Application Publication
(10) Pub. No.: US 2012/0137551 A1
(43) Pub. Date: Jun. 7, 2012

(54) Lighted static cling

(76) Inventor: Jamie Limber, Phoenix, AZ (US)

(21) Appl. No.: 12/928,180

(22) Filed: Dec. 6, 2010

(51) Int. Cl. G09F 13/22; G09F 13/00

(52) U.S. Cl. 40/544; 40/541

(57) ABSTRACT

A device that comprises a sports logo attached to a window adhering structure. The window adhering structure are static cling panels. These panels may be generally the same size and shape as the logo or they may be much larger, such as a large rectangular shape that encompasses the logo. The device further comprises an illumination structure. The illumination structure may be electroluminescent panels, tapes or wires. Additionally, the illumination structure be a series of light elements, such as Light Emitting Diodes (LEDs), each serially connected by conducting wire. Further, the illumination structure includes either a power source that is included in the logo or one that is external to the logo. In the case of the power source that is external to the logo, the power may be provided by a direct current source or an alternating current source, depending on the exact nature of the illuminating structure.

### FIELD OF INVENTION

The present invention relates to illuminated static cling logos and the like.

### BACKGROUND OF INVENTION

Previously sports logos and the like have been attached to windows, walls and the like. However, these products are passive, providing no self illumination.

The present invention solves this problem.

### SUMMARY OF INVENTION

It is an object to provide a logo device, preferably a sports logo device that is attachable to windows and the like by either static cling or suction cups, said logo device also including an illuminating light string.

It is another object of the present invention to provide the logo device, as above, wherein the power for the illuminating light string is contained within the device.

It is yet another object of the present invention to provide the logo device, as above, wherein the illuminating light string is powered by a source external to the logo device.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF DRAWINGS

FIG. 1 is a perspective view of one embodiment of the present invention.

FIG. 2 is a perspective view of a second embodiment of the present invention.

FIG. 3 is a perspective view of third embodiment of the present invention.

FIG. 4 illustrates the present invention used on the window of a vehicle.

FIG. 5 illustrates an embodiment wherein the power for the invention is provided external to the device.

FIG. 6 is an exploded view of a version of the present invention.

FIG. 7 illustrates the present invention used on the windows of a building.

### DETAILED DESCRIPTION

The present invention is an illuminated device 10 useful showing support and affiliation with an entity, preferably a sports franchise or the like.

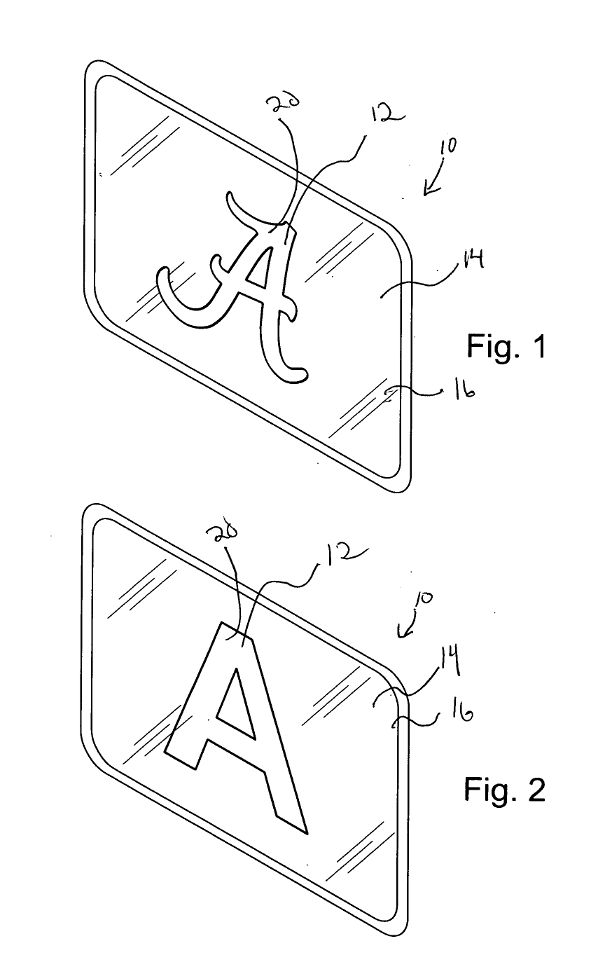

The present invention is a device 10 that comprises a sports logo 12 attached to a window adhering structure 14. In one embodiment, illustrated in FIGS. 1 and 2, the window adhering structure are static cling panels 16. These panels may be generally the same size and shape as the logo or they may be much larger, such as a large rectangular shape that encompasses the logo.

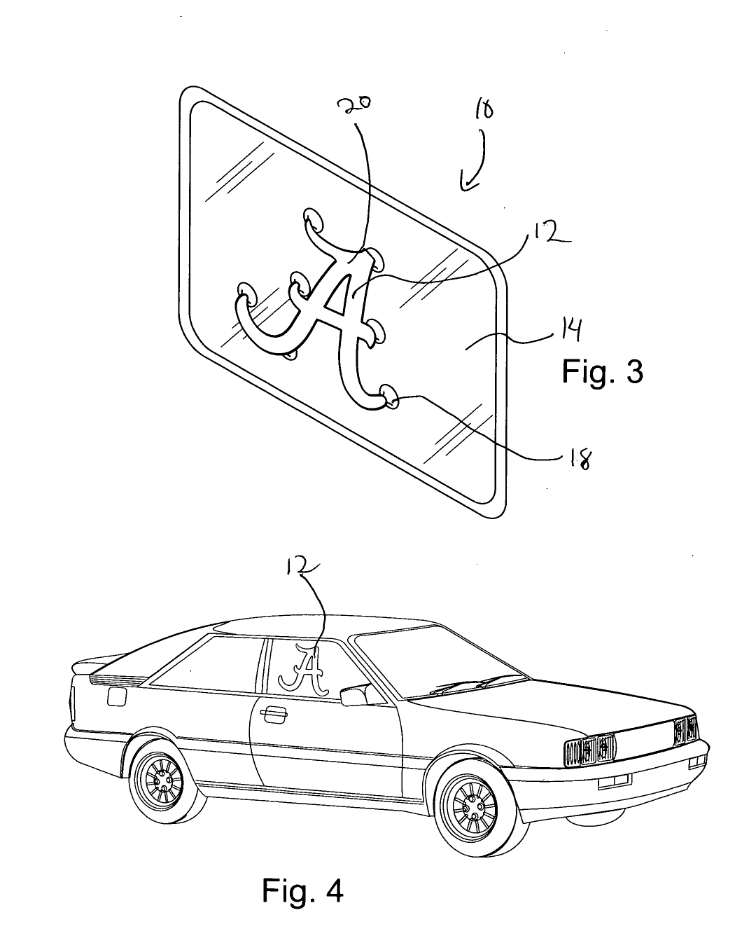

In another embodiment, illustrated in FIG. 3, the window adhering structure may be at least one suction cup 18.

The logo 12 is preferably made of a flexible or quasiflexible or rigid material. The material may be opaque, semiopaque or transparent.

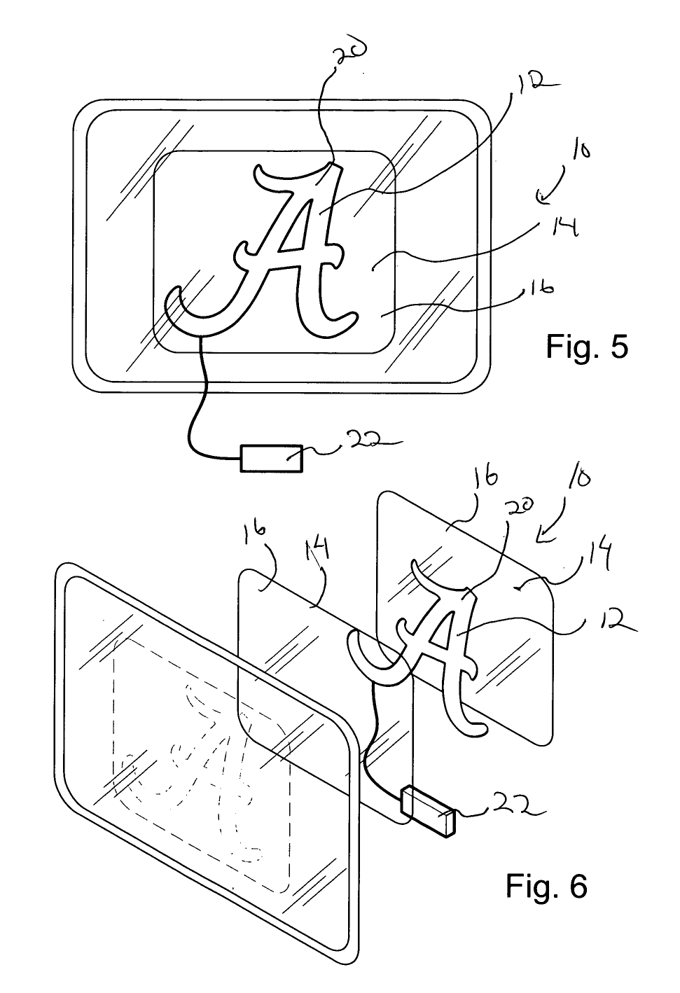

The device 10 of the present invention further comprises an illumination structure 20. The illumination structure may be electroluminescent panels, tapes or wires. Additionally, the illumination structure be a series of light elements, such as Light Emitting Diodes (LEDs), each serially connected by conducting wire. Further, the illumination structure includes either a power source 22 that is included in the logo 12 or one that is external to the logo 12. In the case of the power source 22 that is external to the logo 12, the power may be provided by a direct current source or an alternating current source, depending on the exact nature of the illuminating structure 20. See FIG. 5

As can be seen from FIG. 4, the self contained power source version can be used in places, such as vehicle windows, that are not available to some externally powered versions. FIG. 7 illustrates that both self powered and externally powered versions can be used on the windows of buildings.

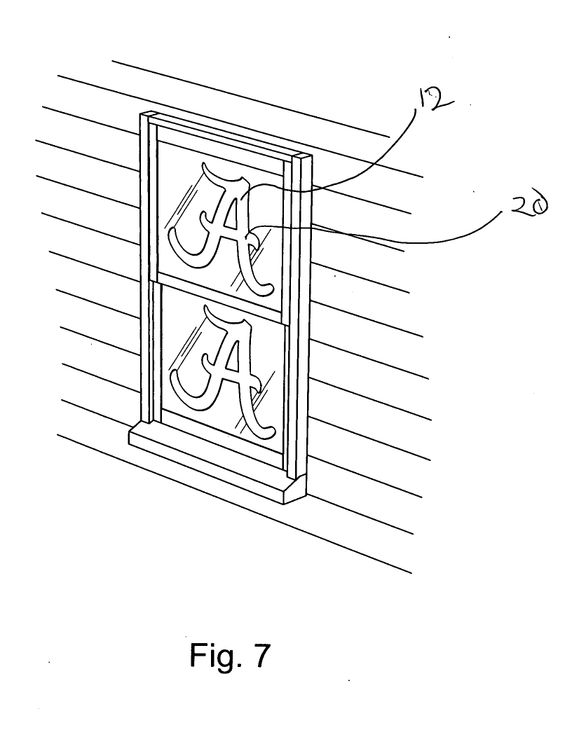

FIG. 6 illustrates the static cling version, where the logo is sandwiched between two panels of static cling 16, in order to allow the logo to be attached to either side of the window.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. An illuminated device for showing entity affiliation comprising a logo, a window adhering structure and an illumination structure.

2. The device according to claim 1, wherein the adhering structure is either at least one static cling panel or at least one suction cup.

3. The device according to claim 1, wherein the illumination structure is selected from the group consisting of electroluminescent panels, tapes, wires, and a string of light emitting diodes.

4. The device according to claim 2, wherein the illumination structure is selected from the group consisting of electroluminescent panels, tapes, wires, and a string of light emitting diodes.
